(19) United States
(12) Patent Application Publication
(10) Pub. No.: US 2009/0123772 A1
(43) Pub. Date: May 14, 2009

(54) HYDROPHILIC COATING METHOD FOR MEDICAL DEVICES

(76) Inventors: Kadem Al-Lamee, Oxfordshire (GB); Martyn Lott, Oxfordshire (GB)

Correspondence Address: Intellectual Property Dept.;Dewitt Ross & Stevens SC, 2 East Mifflin Street, Suite 600, Madison, WI, 53703-2865, US

(21) Appl. No.: 12/160,255

(22) PCT Filed: Jan. 9, 2007
(86) PCT No.: PCT/GB2007/000043

§ 371 Date: Jul. 8, 2008

(30) Foreign Application Priority Data
Jan. 9, 2006 (GB) 0600328.9
Mar. 6, 2006 (GB) 0604474.7

(51) Int. Cl. B32B 27/08; B05D 3/00

(52) U.S. Cl. 428/518; 427/407.1

(57) ABSTRACT

A hydrophilic coating is applied to the surface of a substrate by a method which comprises the steps of (a) applying a first coating comprising a polyvinyl chloride copolymer; and (b) applying a second coating comprising a mixture of a poly(N-vinyl lactam), a polyvinyl chloride copolymer and optionally a zwitterionic compound. Preferably the polyvinyl chloride copolymer is a vinyl chloride-vinyl acetate copolymer. A substrate resulting from the method and a kit for carrying out the method are also provided.

This invention relates to a method for forming a durable lubricious hydrophilic coating on a substrate such as a medical device, and to hydrophilic coatings themselves.

The formation of hydrophilic coatings on substrates has many applications, particularly in medical devices. Such devices that are intended for insertion into body cavities are easily handled when dry and become very slippery after contact with water. Therefore the wetted device can be easily inserted without causing trouble to the patient.

Where a device e.g. a catheter is to remain inside the body even for a relatively short time, there is a tendency for the coating to dry out at a rate beyond that which would be expected merely by evaporation. This causes the catheter to stick, often causing considerable discomfort to the patient. This phenomenon is due to the osmotic potential between bodily fluids in the mucous membranes and the hydrated coating. Water is extracted from the coating through osmosis into the mucous membranes causing the coated surface to dry out.

U.S. Pat. No. 4,906,237 (Astra Meditec AB) discloses the addition of an osmolality increasing compound to the hydrophilic surface of a coated catheter to increase the ambient drying time. Increased drying times reduce the possibility of the catheter sticking when in situ in the urethra. The osmolality increasing compounds include mono and disaccharides, sugar alcohols, and non toxic organic and inorganic salts.

U.S. Pat. No. 5,426,131 (Uno Plast A/B) discloses a method of incorporating or adding an osmolality increasing compound in or to a hydrophilic surface, in a non dissolved, solid or liquid droplet condition. The osmolality increasing compound cited is sodium chloride crystals of size less than 50 μm.

U.S. Pat. No. 6,387,080 (Colorplast A/S) discloses a method of incorporating an osmolality promoting agent onto a surface which was not previously provided with a hydrophilic coating by incorporating the agent into one hydrophilic coating solution and applying in one step. The osmolality promoting agents include urea, amino acids, organic and inorganic acids, polypeptides and mixtures thereof.

U.S. Pat. No. 5,620,738 (Union Carbide) discloses lubricious coatings comprising a binder polymer which is a copolymer of vinyl chloride, vinyl acetate and a carboxylic acid. The main thrust of the invention appears to be the necessity of the carboxylic group for adhesion promotion.

U.S. Pat. No. 4,847,324 (Hydromer Inc) discloses a lubricious coating comprising a hydrophilic blend of polyvinylbutyral (PVB) and a water soluble polyvinylpyrrolidone applied as a one step solution.

U.S. Pat. No. 4,642,267 (Hydromer Inc) discloses a lubricious coating comprising a hydrophilic blend of an organic solvent soluble thermoplastic polyurethane and a water soluble polyvinylpyrrolidone.

U.S. Pat. No. 5,001,009 (Sterilization Technical Services) and U.S. Pat. No. 5,331,027 (Sterilization Technical Services) disclose lubricious coatings comprising a hydrophilic blend of a water insoluble stabilizing polymer selected from the group consisting of a cellulose ester, a copolymer of polymethyl vinyl ether and maleic anhydride, an ester of the copolymer and nylon, and a hydrophilic polymer from the group consisting of polyvinylpyrrolidone, polyvinylpyrrolidone-polyvinyl acetate and mixtures thereof.

In a first aspect of the present invention, there is provided a method of applying a hydrophilic coating to a substrate comprising the steps of (a) applying a first coating comprising a polyvinyl chloride copolymer; and (b) applying a second coating comprising a mixture of a poly(N-vinyl lactam) (such as polyvinylpyrrolidone) and a polyvinyl chloride copolymer.

A polyvinyl chloride copolymer is a polymer comprising at least one vinyl chloride monomer. Generally however it comprises a plurality of vinyl chloride monomers in combination with a plurality of co-monomers, the various monomers being distributed randomly throughout the polymer chain. For example, a vinyl chloride-vinyl acetate-vinyl alcohol copolymer comprises a plurality of vinyl chloride monomers, a plurality of vinyl acetate monomers and a plurality of vinyl alcohol monomers distributed randomly throughout the polymer chain.

Preferably, the polyvinyl chloride copolymer in each coating is independently a vinyl chloride-vinyl acetate copolymer, poly(vinyl chloride-co-vinyl acetate-co-vinyl alcohol); poly(vinyl chloride-co-vinyl acetate-co-2-hydroxypropyl acrylate); poly(vinyl chloride-co-vinyl acetate-co-maleic acid), and most preferably a vinyl chloride-vinyl acetate copolymer. The polyvinyl chloride copolymer of the second coating is preferably the same as that of the first.

In a particularly preferred embodiment, the method comprises the step of applying a zwitterionic solution to the substrate, for example in the form of a zwitterionic compound included in the second coating as defined above or in a third coating. The zwitterionic compound is preferably a betaine compound such as a carboxy, sulfo or phospho betaine compound or derivatives thereof for example alkylbetaines or amidoalkylbetaines.

A zwitterionic compound is a compound having separate acidic and basic groups in the same molecule. At neutral pH the compound therefore has separate anionic and cationic groups.

It has been discovered that zwitterion compounds (preferably those that are soluble in organic solvents) delay drying of a substrate surface due to their ability to retain water. A typical group of zwitterions is the betaine group of compounds which exist as carboxybetaine, sulfobetaine or phosphobetaine molecules. Examples of such zwitterions are cocamidopropyl betaine, oleamidopropyl betaine, lauryl sulfobetaine, myristyl sulfobetaine, betaine (trimethylglycine), octyl betaine and phosphatidylcholine. It will be appreciated that many more zwitterions may be applicable and by mentioning the above this does not limit the scope of the invention.

It has also been found that these zwitterions compounds do not interfere with the bioactivity of any antimicrobial agents added to this system.

In a second aspect of the present invention, there is provided a method for coating a substrate comprising applying a coating to the surface, wherein said coating comprises at least one polymer and a zwitterion compound.

Preferably, the method comprises:

(i) applying to the surface a solution of a first polymer; and
(ii) applying to the surface a solution of the first polymer, a second polymer and a zwitterion compound.

In a third aspect of the present invention, there is provided a hydrophilic coating for a substrate, comprising a solution of at least one polymer and a zwitterion compound.

A number of preferred embodiments of the present invention will now be described by way of example.

A hydrophilic polymer blend is disclosed which comprises a first polymer component which is an organic solvent soluble polyvinylchloride copolymer and a second polymer component which is a hydrophilic poly(N-vinyl lactam). The blend and the method of preparation provide coated articles, comprising preferably but not limited to PVC substrates, which are slippery in aqueous environments but non slippery when dry, whilst maintaining significant adhesion and durability.

The preferred coating method of the invention involves preparing a solution of the solvent soluble PVC copolymer and a solution comprising the PVC copolymer, the poly(N-vinyl lactam) and a zwitterion compound and coating the substrate first in the former and then the latter. The optimum coating method is demonstrated best by way of example.

### Materials

### Polymers

### Polyvinylpyrrolidone

Kollidon 90F average M_{w}˜1,500,000: BASF
Poly(Vinyl chloride-co-vinyl acetate-co-vinyl Alcohol)
UCAR solution vinyl resin VAGD M_{w}˜22,000: Dow Chemical Company
Poly(Vinyl chloride-co-vinyl acetate-co-maleic Acid)

### M_{w}˜15000: Sigma Aldrich

Poly(Vinyl chloride-co-vinyl acetate-co-2-hydroxylpropyl Acrylate)

### M_{w}˜24000: Sigma Aldrich

### Additives

### Betaine: M_{w}˜117.15: Sigma Aldrich

[Synonyms: Glycine betaine; Trimethylglycine, 1-Carboxy-N,N,N-trimethylmethanaminium hydroxide inner salt]
Octyl sulfobetaine: M_{w}˜279.6: Merck Biosciences
[Synonym: n-Octyl-N,N-dimethyl-3-ammonio-1-propanesulfonate]
Decyl sulfobetaine: M_{w}˜307.5: Sigma Aldrich
[Synonym: 3-(Decyldimethyl-ammonio)propanesulfonate inner salt]
Lauryl sulfobetaine: M_{w}˜335.55: Sigma Aldrich
[Synonym: N-Dodecyl-N,N-dimethyl-3-ammonio-1-propanesulfonate]
Myristyl sulfobetaine: M_{w}˜363.61: Sigma Aldrich

### [Synonym: 3-(N,N-Dimethylmyristyl-ammonio)propanesulfonate]

Octyl betaine: Mackam OCT-LS M_{w}˜215.34: McIntyre Group Ltd
[Synonym: n-Octyl-N,N-dimethyl Betaine]

### Lauryl Betaine; Mackam LB-35: M_{w}˜271.45: McIntyre Group Ltd

### [Synonym: N-Dodecyl-N,N-dimethylbetaine]

### Coco Betaine: Mackam CB-35: M_{w}˜Mixture: McIntyre Group Ltd

[Synonym: Coco dimethyl glycine]
Caprylamidopropyl betaine; Tego Betaine 810: M_{w}˜287.42: Goldschmidt GmbH

### Lauroamidopropyl Betaine; Mackam LMB: M_{w}˜315.48: McIntyre Group Ltd

[Synonym: N-(Dodecylamidopropyl)-N,N-dimethylammonium betaine]

### Cocamidopropyl Betaine; Mackam 35: McIntyre Group Ltd

### Oleamidopropyl Betaine; Mackam HV: M_{w}˜424.67: McIntyre Group Ltd

[Synonym: Oleamidopropyl dimethyl glycine]

### Solvents

### 2-Propanol: Sigma Aldrich

### Acetone: Sigma Aldrich

### Methanol: Sigma Aldrich

### EXAMPLE 1

A number of PVC tubes (d=0.47 mm) were cleaned with 2-Propanol and air dried for approx 10 minutes. Tubes were dipped in a 5% w/v solution of Poly(vinyl chloride-co-vinyl acetate-co-vinyl alcohol) in acetone and dried at 70° C. for 15 minutes. The tubes were subsequently split into four groups and respectively coated with 8% w/v coatings comprising Polyvinylpyrrolidone and Poly(vinyl chloride-co-vinyl acetate-co-vinyl alcohol) in acetone/IPA (60:40 v/v) at the following polymer ratios 80:20, 85:15, 93.75:6.25 and 97:3. The coated tubes were then dried at 70° C. for 30 minutes.

All coatings were clear and non lubricious when dry, but whitened and lubricious after immersion in water.

As would be expected the lubricity of the samples increased with increasing ratio of Polyvinylpyrrolidone to Poly(vinyl chloride-co-vinyl acetate-co-vinyl alcohol). However, a noticeable loss in durability was present at the highest ratio (97:3). At the optimum polymer ratio the COF was <<0.05.

### EXAMPLE 2

### Alternative Modified Vinyl Chloride/Vinyl Acetate Co Polymer Binders

This example aims to demonstrate that similar results are obtained regardless of how the vinyl chloride/vinyl acetate has been modified.

PVC tubes were cleaned with 2-propanol and air dried for 10 minutes.

Three 8% w/v coating solutions were prepared comprising polyvinylpyrrolidone and the following vinyl chloride/vinyl acetate co polymers in Acetone/IPA (62:38) at a polymer ratio of 93.75:6.25 respectively
1. Poly(vinyl chloride-co-vinyl acetate-co-2-hydroxypropyl acrylate)
2. Poly(vinyl chloride-co-vinyl acetate-co-maleic acid)
3. Poly(vinyl chloride-co-vinyl acetate-co-vinyl alcohol)

Each set of tubes was first dip coated with a 5% w/w solution of the respective vinyl chloride/vinyl acetate co polymer only and dried for 15 mins at 70° C.

The tubes were subsequently dip coated in the respective 8% w/v hydrophilic coating solution and dried for 30 mins at 70° C.

All coatings were clear and non lubricious when dry but whitened and lubricious when immersed in water. The coatings were strongly attached to the tubing and gave a good level of lubricity when wetted. No difference in lubricity or durability could be detected between the three vinyl chloride/vinyl acetate co polymer variants. The main thrust of U.S. Pat. No. 5,620,738 (Union Carbide) appears to be the necessity of carboxylic groups in the vinyl chloride/vinyl acetate polymer for adhesion promotion. However, in this application, there is clearly no additional benefit associated with this moiety.

### EXAMPLE 3

### Addition of 2% Sulfobetaine Zwitterion

This example aims to demonstrate the effectiveness of zwitterion addition by simply replacing a proportion of Polyvinylpyrrolidone from the optimum formulation in Example 1 (ratio 93.75:6.25) with a zwitterion.

A number of PVC tubes (d=0.47 mm) were cleaned with 2-Propanol and air dried for approx 10 minutes, Tubes were then dipped in a 5% w/v solution of Poly(vinyl chloride-co-vinyl acetate-co-vinyl alcohol) in acetone and dried at 70° C. for 15 minutes. The tubes were subsequently split into four groups with each group being coated with an 8% w/v coating comprising Polyvinylpyrrolidone, Poly(vinyl chloride-co-vinyl acetate-co-vinyl alcohol) and one of four zwitterions at an overall ratio of 91.75:6.25:2 w/w in IPA/Methanol/Acetone (36:2:62v/v). The zwitterions additives were

### Octyl Sulfobetaine,

### Decyl Sulfobetaine

### Lauryl Sulfobetaine

### Myristyl Sulfobetaine

The coatings were dried at 70° C. for 30 minutes.

The coatings were clear and non lubricious when dry, but whitened and became highly lubricious and durable when immersed in water. No differences in lubricity were detected between the different groups

A comparative drying test was carried out between the samples in this example and the optimum sample from Example 1 (i.e. with no zwitterions additive), herein referred to as the “standard”.

Samples were hydrated for 30 seconds and hung vertically in a shielded, transparent chamber at ambient temperature and humidity level of ˜40%. “Dry out” was assessed by touch and visible appearance of the coating after an extended time of 20 minutes. It was clear, by touch and visibility, that, when compared to the standard, the addition of the sulfobetaine zwitterion increased water retention thus retarding the drying of the coated catheters. Dry out performance was as follows:

### Standard<Octyl<Decyl<Lauryl<Myristyl

where the myristyl sulfobetaine has the best (i.e. the slowest) “dry out” performance. In this case increasing molecular weight of the sulfobetaine improves dry out performance.

### EXAMPLE 4

### Addition of 5% Sulfobetaine Zwitterions

This example aims to demonstrate the effectiveness of different concentrations of zwitterion addition

A number of coated PVC tubes (d=0.47 mm) were prepared as in Example 3 with the exception that the level of zwitterion was increased from 2% to 5%. The resulting ratio of Polyvinylpyrrolidone: Poly(vinyl chloride-co-vinyl acetate-co-vinyl alcohol): zwitterions thus changed to 88.75:6.25:5 w/w and solvent ratio 33:5:62v/v (IPA/Methanol/Acetone), The coatings were clear and non lubricious when dry, but whitened and became highly lubricious and durable when immersed in water. No differences in lubricity were detected between the different groups

A comparative drying test, as in example 3 was carried out between the samples in this example and the standard. It was clear once again, by touch and visibility, that, when compared to the standard, the addition of sulfobetaine zwitterions increased water retention thus retarding the drying of the coated catheters. Dry out performance was as follows:

### Standard<Octyl<Decyl<Lauryl<Myristyl

where the myristyl sulfobetaine has the best (i.e. the slowest) “dry out” performance.

Generally, the samples in this example demonstrated slightly improved dry out performance when compared to those in example 2, but with a slight reduction in lubricity.

### EXAMPLE 5

### Addition of 2% Alkylbetaine Zwitterions

A number of coated PVC tubes (d=0.47 mm) were prepared as in Example 3 with the exception that the zwitterions additives (2% w/w) were alkylbetaines, namely:

### Betaine

Octyl betaine
Coco betaine
Lauryl betaine

Those alkyl betaines that were supplied as aqueous solutions were evaporated to dryness before being solubilised in methanol and formulated into the hydrophilic coating

The coatings were clear and non lubricious when dry, but whitened and became highly lubricious and durable when immersed in water. No differences in lubricity were detected between the different groups.

A comparative drying test was carried out as in example 3 against the standard.

It was clear once again, by touch and visibility, that, when compared to the standard, the addition of alkyl betaine zwitterions increased water retention thus retarding the drying of the coated catheters. Dry out performance was as follows

### Standard<Betaine<Coco<Lauryl<Octyl

where the Octyl betaine has the best (i.e. the slowest) “dry out” performance.

### EXAMPLE 6

### Addition of 2% Amidopropyl Betaine Zwitterions

A number of coated PVC tubes (d=0.47 mm) were prepared as in Example 3 with the exception that the zwitterions additives (2% w/w) were amidopropyl betaines, namely:

Capramidopropyl betaine
Lauroamidopropyl betaine
Cocamidopropyl betaine
Oleamidopropyl betaine

Those amidopropyl betaines that were supplied as aqueous solutions were evaporated to dryness before being solubilised in methanol and formulated into the hydrophilic coating.

The coatings were clear and non lubricious when dry, but whitened and became highly lubricious and durable when immersed in water. No differences in lubricity were detected between the different groups.

A comparative drying test was carried out as in example 3 against the standard.

It was clear, by touch and visibility, that in all but one of the cases, when compared to the standard, the addition of amidopropyl betaine zwitterions increased water retention thus retarding the drying of the coated catheters. Dry out performance was as follows:

### Capramido<Standard<Oleamido<Lauramido<Cocamido

where the cocamidopropyl betaine has the best (i.e. the slowest) “dry out” performance.

1.-16. (canceled)

17. A method of applying a hydrophilic coating to a substrate comprising the steps of:
(a) applying a first coating comprising a polyvinyl chloride copolymer; and
(b) applying a second coating comprising a mixture of a poly(N-vinyl lactam) and a polyvinyl chloride copolymer.

18. A method as claimed in claim 17, wherein the polyvinyl chloride copolymer in each coating is independently a vinyl chloride-vinyl acetate copolymer; poly(vinyl chloride-co-vinyl acetate-co-vinyl alcohol); poly(vinyl chloride-co-vinyl acetate-co-2-hydroxypropyl acrylate); poly(vinyl chloride-co-vinyl acetate-co-maleic acid).

19. A method as claimed in claim 18, wherein the polyvinyl chloride copolymer in each coating is independently a vinyl chloride-vinyl acetate copolymer.

20. A method as claimed in claim 17, wherein the polyvinyl chloride copolymer of the second coating is the same as that of the first.

21. A method as claimed in claim 18, wherein the polyvinyl chloride copolymer of the second coating is the same as that of the first.

22. A method as claimed in claim 19, wherein the polyvinyl chloride copolymer of the second coating is the same as that of the first.

23. A method as claimed in claim 17, wherein the second coating additionally comprises a zwitterionic compound.

24. A method as claimed in claim 23, wherein the zwitterionic compound is a betaine compound.

25. A method as claimed in claim 24, wherein the betaine compound is a carboxy, sulfo or phospho betaine compound or derivatives thereof.

26. A method as claimed in claim 18, wherein the second coating additionally comprises a zwitterionic compound.

27. A method as claimed in claim 26, wherein the zwitterionic compound is a betaine compound.

28. A method as claimed in claim 27, wherein the betaine compound is a carboxy, sulfo or phospho betaine compound or derivatives thereof.

29. A method as claimed in claim 19, wherein the second coating additionally comprises a zwitterionic compound.

30. A method as claimed in claim 29, wherein the zwitterionic compound is a betaine compound.

31. A method as claimed in claim 30, wherein the betaine compound is a carboxy, sulfo or phospho betaine compound or derivatives thereof.

32. A method as claimed in claim 20, wherein the second coating additionally comprises a zwitterionic compound.

33. A method as claimed in claim 32, wherein the zwitterionic compound is a betaine compound.

34. A method as claimed in claim 33, wherein the betaine compound is a carboxy, sulfo or phospho betaine compound or derivatives thereof.

35. A method as claimed in claim 17, additionally comprising applying a third coating comprising a zwitterionic compound.

36. A method as claimed in claim 35, wherein the zwitterionic compound is a betaine compound.

37. A method as claimed in claim 36, wherein the betaine compound is a carboxy, sulfo or phospho betaine compound or derivatives thereof.

38. A method as claimed in claim 18, additionally comprising applying a third coating comprising a zwitterionic compound.

39. A method as claimed in claim 38, wherein the zwitterionic compound is a betaine compound.

40. A method as claimed in claim 39, wherein the betaine compound is a carboxy, sulfo or phospho betaine compound or derivatives thereof.

41. A method as claimed in claim 19, additionally comprising applying a third coating comprising a zwitterionic compound.

42. A method as claimed in claim 41, wherein the zwitterionic compound is a betaine compound.

43. A method as claimed in claim 42, wherein the betaine compound is a carboxy, sulfo or phospho betaine compound or derivatives thereof.

44. A method as claimed in claim 20, additionally comprising applying a third coating comprising a zwitterionic compound.

45. A method as claimed in claim 44, wherein the zwitterionic compound is a betaine compound.

46. A method as claimed in claim 45, wherein the betaine compound is a carboxy, sulfo or phospho betaine compound or derivatives thereof.

47. A method as claimed in claim 21, additionally comprising applying a third coating comprising a zwitterionic compound.

48. A method as claimed in claim 47, wherein the zwitterionic compound is a betaine compound.

49. A method as claimed in claim 48, wherein the betaine compound is a carboxy, sulfo or phospho betaine compound or derivatives thereof.

50. A method as claimed in claim 17, wherein the poly(N-vinyl lactam) is polyvinylpyrrolidone.

51. A method as claimed in claim 17, wherein at least one of the coatings comprises a bioactive compound.

52. A method as claimed in claim 17, wherein the substrate is a medical device.

53. A method for increasing the hydrophilic nature of a coating for the surface of a substrate, comprising incorporating a zwitterionic compound into the coating.

54. A method for increasing the dry out performance of a hydrophilic coating on a substrate comprising adding an additional coating layer comprising a zwitterionic compound.

55. A coated substrate obtainable by
(a) applying a first coating comprising a polyvinyl chloride copolymer; and
(b) applying a second coating comprising a mixture of a poly(N-vinyl lactam) and a polyvinyl chloride copolymer.

56. A kit comprising:
a first coating comprising a polyvinyl chloride copolymer; and
a second coating comprising a mixture of a poly(N-vinyl lactam) and a polyvinyl chloride copolymer.

57. A kit as claimed in claim 56, further comprising a third coating solution comprising a zwitterionic compound.
